(19) United States
(12) Patent Application Publication
(10) Pub. No.: US 2004/0246335 A1
(43) Pub. Date: Dec. 9, 2004

(54) N-times multiplied enlarging system of a microscopic view observation of any object (including infinitesimal objects) on several stages The system comprises microscopes, digital video cameras, computers, and TV's in a circuit

(76) Inventors: George Abdel Messih Zaki, Jersey city, NJ (US); Hassan El' Gohary, Paris (FR); Wahid Raafat Elnashfan, Jersey city, NJ (US); Wadie Khalil, Jersey city, NJ (US)

Correspondence Address: George Abdel Messih Zaki, P. o. Box 6448, Jersey city, NJ, 07306, US

(21) Appl. No.: 10/453,281

(22) Filed: Jun. 4, 2003

(51) Int. Cl. H04N 7/18

(52) U.S. Cl. 348/79

(57) ABSTRACT

A n-times multiplied enlarging system of a microscopic view of any object (including infinitesimal objects) on several stages in a closed circuit comprising computers, microscopes, digital video cameras and TV's (with a screen equal in size or less than the objective lens of the microscopes used).

First Enlarging Operation:

The view of the object obtained by a microscope is transmitted to the first personal computer by means of the first digital video camera.

The computer screen image of the magnified object as a whole or in part is then transmitted to the TV screen by means of a second video camera.

Second Enlarging Operation

The enlarged image on the TV screen of the object is then treated as an object to be enlarged by means of the second microscope.

A third digital video camera then transmits the image obtained by the second microscope in the previous step to the second P.C.

N-Times Enlarging Operation

By means of the fourth digital video camera, the digitalized microscopic image, will be transmitted again to the second T.V. (with a high resolution screen). The whole image on the T.V. screen is then treated as an object to be enlarged in the following steps if more enlarging is needed.

The previous process is repeated as many times as it takes to reach a sufficient ratio to enlarge and clearly view a specific infinitesimal object.

A n-times multiplied enlarging system of a microscopic view observation of any object (including infinitesimal objects) on several stages. The system comprises microscopes, digital video cameras, computers, and TV's in a circuit.

### BACKGROUND OF THE INVENTION

The magnifying capacity of the most powerful microscope does not exceed 300,000 times the object (presently).

Many infinitesimal objects such as the atom (and its structure) and the components of some living creatures or cells were never seen, monitored or studied using this (or any lower) magnifying capacity.

Electronic microscopes are also sophisticated, expensive, costly to run, out of the reach of many researchers and needs a lot of space.

All the above and more created a need to a magnifying method that allows the researchers to view monitor and study infinitesimal objects that an electronic microscope is presently unable to help researchers view, monitor and study because of its limitations.

### FIELD OF THE INVENTION

The suggested system of magnifying on multiple stages allows researchers to view, monitor and study objects that were impossible to be seen before because of the limitations of the capacity of the electronic microscope.

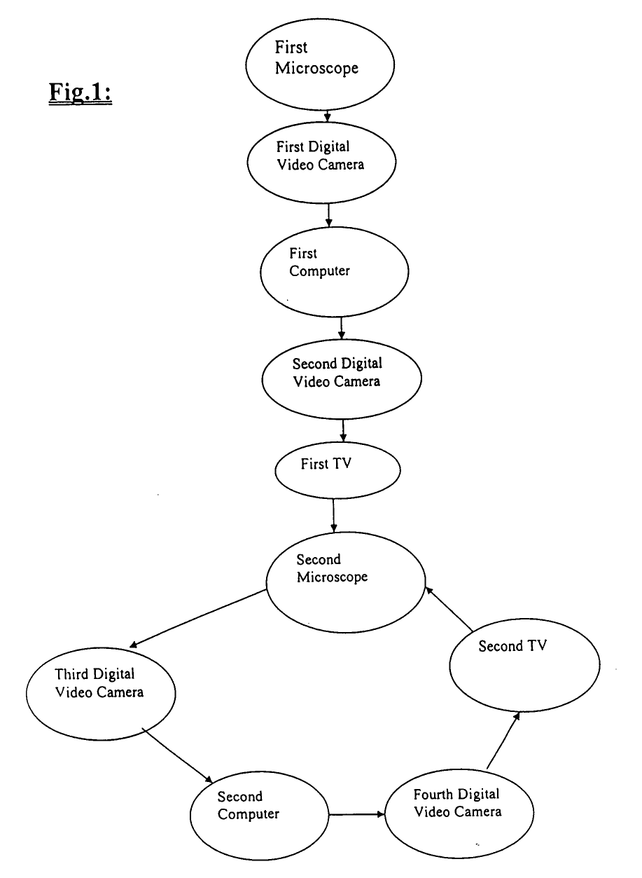

### BREIF DESCRIPTION OF FIG. 1

FIG. 1 is a flowchart that shows a multiplied enlarging system of a microscopic image of any object by means of a closed circuit.

The system's circuit is in the following order:

1—The first microscope;

2—The first digital video camera;

3—The first personal computer;

4—The second digital video camera;

5—The first T.V.

6—The second microscope;

7—The third digital video camera;

8—The second personal computer.

9—The fourth digital video camera.

10—The second T.V

### DETAILED DESCRIPTION OF THE INVENTION

FIG. 1 is a flowchart that shows a multiplied enlarging system of a microscopic image of any object by means of a closed circuit.

The system's circuit is in the following order:

1—The first microscope;

2—The first digital video camera;

3—The first personal computer;

4—The second digital video camera;

5—The first T.V.

6—The second microscope;

7—The third digital video camera;

8—The second personal computer.

9—The fourth digital video camera.

10—The second T.V.

### Steps of the Enlarging/Magnifying Process

(1) The object/specimen is exposed to a light source or a laser beam source to obtain its microscopic view by means of the first microscope.

To increase the intensity of light we use convex lenses to focus the light beams on the object/specimen. This helps us obtain the best resolution possible in the following steps.

(2) This image is then transmitted to a personal computer by means of the first digital video camera. The image is saved in a digital form and the computerized image (as a whole or in part) may be used in the following steps (or without further enlarging if this enlarging ratio is sufficient).

(3) By means of the second digital video camera, the computerized image (as a whole or in part) is to be transmitted to the first T.V. (with a high resolution screen that is equal in size or smaller than the objective lens of the microscope used). The whole image on the T.V. screen is then treated as an object to be enlarged in the following step.

(4) By means of the second microscope we obtain a microscopic view of the T.V. screen image. The second microscope will enlarge the previously enlarged computerized T.V. image of the object to its maximum power. At this stage, more details of the specimen's composition could be observed.

(5) A third digital video camera then transmits the image obtained by the second microscope in the previous step to the second P.C.

(6) By means of the fourth digital video camera, the digitalized microscopic image, will be transmitted again to the second T.V. (with a high resolution screen). The whole image on the T.V. screen is then treated as an object to be enlarged in the following steps if more enlarging is needed.

(7) Steps 4 through 6 of the process are repeated as many times as it takes to reach a sufficient ratio to enlarge and clearly view a specific infinitesimal object.

(8) Assuming that the computer software and the digital video cameras will not contribute to the enlargement process, the enlarging capacity of this method=number of times the process is repeated maximum enlarging power of microscope 1×(maximum enlarging power of microscope 2)

1. An enlarging system that magnifies the microscopic image of an infinitesimal object/specimen allowing researchers to view, monitor and study objects/specimens they were unable to study using the electronic microscope that comprises:
A light or laser beam source and convex lenses.
Two identical compound microscopes.
Four identical digital video cameras with the highest resolution possible.
Two personal computers with a high definition plasma screen.
Two small televisions (with a screen equal or smaller in size to the objective lens of the compound microscope used).

2. An enlarging system as in claim 1 wherein we use convex lenses to focus/intensify the light on the infinitesimal object/specimen (or we may use a laser beams source) to insure that we get the best resolution possible of the microscopic view and accordingly the best resolution in every following enlarging step of the microscopic image.

3. An enlarging system as in claim 1 wherein the digital video cameras are used to transmit the enlarged images (or the microscopic views) of the infinitesimal object/specimen to the computer and the portion we want to further magnify on the computer screens to the TV.

4. An enlarging system as in claim 1 wherein the enlarged digital image transmitted to the TV by means of the digital video camera is treated as an object to be enlarged by a second microscope in the following steps of the enlarging process.

5. Assuming that the computer software and the digital video cameras will not contribute to the enlarging capacity of the system explained in claim 1 the enlarging capacity of the system=number of times the process is repeated maximum enlarging power of microscope 1×(maximum enlarging power of microscope 2)

6. An enlarging system as in claim 1 wherein the enlarging steps are repeated as many times as it takes to reach a sufficient ratio to enlarge and clearly view a specific infinitesimal object.
